(19) United States
(12) Patent Application Publication
(10) Pub. No.: US 2026/0158619 A1
(43) Pub. Date: Jun. 11, 2026

(54) DRIVE DEVICE, A VICE, AN ASSEMBLY WITH A DRIVE DEVICE AND A METHOD FOR OPERATING SUCH AN ASSEMBLY

(71) Applicant: zwo17 GmbH & Co. KG, MARKT INDERSDORF (DE)

(72) Inventor: Norbert EUGLER, KARLSFELD (DE)

(21) Appl. No.: 19/179,673

(22) Filed: Apr. 15, 2025

(30) Foreign Application Priority Data
Apr. 16, 2024 (DE) 102024001205.2

(51) Int. Cl. B25B 1/06; B25B 1/02

(52) U.S. Cl. CPC B25B 1/06; B25B 1/02

(57) ABSTRACT

A drive device with a drive for a vice, a coupling assembly and a socket wrench rotatable about an axis, in which the socket wrench is movable in the direction of the axis, as well as a vice with a side on which a drive spindle is disposed, which has a coupling assembly counterpiece which is disposed on the side of the drive spindle. Also, an assembly with a drive device which is positively connected with the vice and a method for operating such an assembly.

### CROSS-REFERENCES TO RELATED APPLICATIONS

This application claims the benefit of German Patent Application Number 102024001205.2 filed on Apr. 16, 2024, the entire disclosure of which is incorporated herein by way of reference.

### FIELD OF THE INVENTION

The invention relates to a drive device with a drive for a vice, a coupling assembly and a socket wrench rotatable about an axis, a vice with a side on which a drive spindle is disposed, an assembly with a drive device and a vice and a method for operating such an assembly.

### BACKGROUND OF THE INVENTION

An underlying problem of the invention is to improve such devices and methods.

This problem may be solved with devices and methods according to one or more embodiments described herein.

### SUMMARY OF THE INVENTION

In particular, a solution of the problem to be solved involves attaching a drive to a vice quickly and without tools. Thereby, the vice can be adjusted and set up manually with a wrench and automated for the start of the series. By using an interchangeable adapter plate, almost all vices can be operated.

Therefore, in one aspect, the present invention may be generally characterized as providing a drive device having: a drive for a vice; a coupling assembly; and a socket wrench configured to rotate about an axis, wherein the socket wrench is movable in the direction of the axis.

The coupling assembly may utilize a positive-locking fastening assembly as a torque input.

The coupling assembly may include an interchangeable adapter plate.

The drive device may also include a rotary handle configured to displace the socket wrench in the direction of the axis.

The derive device may include a rotary handle is disposed laterally on the drive on a side of the drive opposite to the coupling assembly or on a side located between the coupling assembly and a side opposite to the coupling assembly.

In a second aspect the present invention may be, broadly, characterized as providing a vice with a drive device according to the present disclosure and a coupling assembly counterpiece which is disposed on a side of a drive spindle.

The coupling assembly counterpiece may include heads which are disposed on a side of the drive spindle. The heads may be disposed in a triangle. The heads may be screwed into threads or inserted into a mating fit.

In a third aspect, the present invention may be broadly categorized as providing an assembly of a drive device according to the present disclosure and a vice having a coupling assembly counterpiece which is disposed on a side of a drive spindle. The drive device may be positively connected with the vice.

In the assembly, the coupling assembly may include an interchangeable adapter plate, and the interchangeable adapter plate may be axially displaceable relative to the vice.

Additionally and alternatively, the coupling assembly may include an interchangeable adapter plate, and the interchangeable adapter plate may be rotationally displaceable relative to the vice.

In a third aspect, the present invention, generally, may be categorized as providing a method for operating an assembly according to the present disclosure by: coupling the drive device to the vice; moving the socket wrench of the drive device over the drive spindle of the vice; and rotating the drive spindle with the socket wrench.

The drive device may be fastened on the vice in order to couple the drive device with the vice.

The socket wrench may be moved via the drive spindle of the vice by turning a rotary handle.

### BRIEF DESCRIPTION OF THE DRAWINGS

An advantageous exemplary embodiment is shown in the drawing and is described in the following.

FIG. 1 shows a drive with an exchangeable adapter plate 1 and a vice with matching attached counterpieces 2, which can be designed as knobs. Three threads are provided in the vice in order to mount the counterpieces. The counterpieces can also be pressed in without threads.

FIG. 2 shows another drive with an exchangeable adapter plate 1 and a vice with matching attached counterpieces 2, which is designed as knobs. Three threads are provided in the vice in order to mount the counterpieces. The counterpieces can also be pressed in without threads.

FIG. 3 shows the docking of the drive before the adapter plate is positively locked. The socket wrench 3 of the drive is axially displaceable and is located before the vice spindle 4, when retracted.

FIG. 4 shows the drive in a “docked” position. The advantage of all this is that the socket wrench is moved over the spindle 5 and thus the adapter plate is locked and secured to the vice. The axial displacement of the socket wrench is achieved via a rotary handle 6 with an internal threaded rod (not shown). The displacement can also occur by motor or with a pneumatic or hydraulic cylinder via a button.

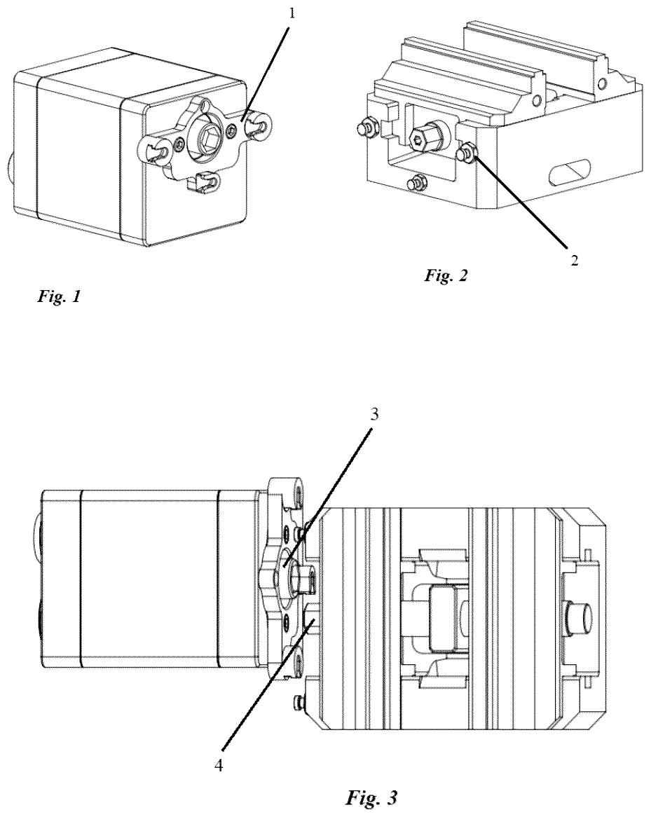

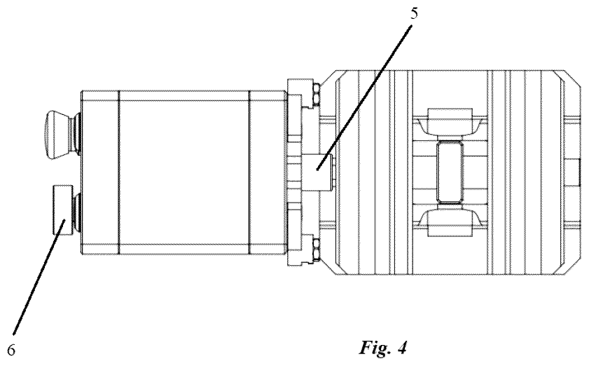

### DETAILED DESCRIPTION OF THE PREFERRED EMBODIMENTS

The drive is docked and locked manually, but the opening or closing of the vice then occurs electrically or pneumatically or hydraulically.

In doing so, there are two scenarios.

First, the worker manually inserts the workpieces into the vice, then closes/opens the vice with two buttons at the back (not shown). The mushroom head is an emergency stop switch. The advantage is that the workpiece is always clamped in equally tightly in a reliable process and the worker can operate the vice ergonomically without any effort.

Second, a robot is placed at the machine to insert the workpiece, then the robot controls the drive, opens or closes the vice, in which case the buttons have no function. This has the advantage that a robot can still hold the part in the vice during the opening/closing process and the whole process is particularly fast.

The systems and devices described herein may include a controller or a computing device comprising a processing unit and a memory which has stored therein computer-executable instructions for implementing the processes described herein. The processing unit may comprise any suitable devices configured to cause a series of steps to be performed so as to implement the method such that instructions, when executed by the computing device or other programmable apparatus, may cause the functions/acts/steps specified in the methods described herein to be executed. The processing unit may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory may be any suitable known or other machine-readable storage medium. The memory may comprise non-transitory computer readable storage medium such as, for example, but not limited to, an electronic, magnetic, optical, electromagnetic, infrared, or semiconductor system, apparatus, or device, or any suitable combination of the foregoing. The memory may include a suitable combination of any type of computer memory that is located either internally or externally to the device such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. The memory may comprise any storage means (e.g., devices) suitable for retrievably storing the computer-executable instructions executable by processing unit.

The methods and systems described herein may be implemented in a high-level procedural or object-oriented programming or scripting language, or a combination thereof, to communicate with or assist in the operation of the controller or computing device. Alternatively, the methods and systems described herein may be implemented in assembly or machine language. The language may be a compiled or interpreted language. Program code for implementing the methods and systems described herein may be stored on the storage media or the device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein.

Computer-executable instructions may be in many forms, including modules, executed by one or more computers or other devices. Generally, modules include routines, programs, objects, components, data structures, etc., that perform particular tasks or implement particular abstract data types. Typically, the functionality of the modules may be combined or distributed as desired in various embodiments.

It will be appreciated that the systems and devices and components thereof may utilize communication through any of various network protocols such as TCP/IP, Ethernet, FTP, HTTP and the like, and/or through various wireless communication technologies such as GSM, CDMA, Wi-Fi, and WiMAX, is and the various computing devices described herein may be configured to communicate using any of these network protocols or technologies.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

Claimed is:

1. A drive device comprising:
a drive for a vice;
a coupling assembly; and
a socket wrench configured to rotate about an axis, wherein the socket wrench is movable in a direction of the axis.

2. The drive device according to claim 1, wherein the coupling assembly comprises a positive-locking fastening assembly as a torque input.

3. The drive device according to claim 1, wherein the coupling assembly has an interchangeable adapter plate.

4. The drive device according to claim 1, further comprising:
a rotary handle configured to displace the socket wrench in the direction of the axis.

5. The drive device according to claim 1, wherein a rotary handle is disposed laterally on the drive on a side of the drive opposite to the coupling assembly or on a side located between the coupling assembly and a side opposite to the coupling assembly.

6. A vice comprising:
the drive device according to claim 1; and,
a coupling assembly counterpiece which is disposed on a side of a drive spindle.

7. The vice according to claim 6, wherein the coupling assembly counterpiece comprises heads which are disposed on a side of the drive spindle.

8. The vice according to claim 7, wherein the heads are disposed in a triangle.

9. The vice according to claim 7, wherein the heads are screwed into threads or inserted into a mating fit.

10. An assembly comprising:
the drive device according to claim 1; and
a vice comprising a coupling assembly counterpiece which is disposed on a side of a drive spindle,
wherein the drive device is positively connected with the vice.

11. The assembly according to claim 10, wherein the coupling assembly has an interchangeable adapter plate, and
wherein the interchangeable adapter plate is axially displaceable relative to the vice.

12. The assembly according to claim 10, wherein the coupling assembly has an interchangeable adapter plate, and
wherein the interchangeable adapter plate is rotationally displaceable relative to the vice.

13. A method for operating the assembly according to claim 10, comprising:
coupling the drive device to the vice;
moving the socket wrench of the drive device over the drive spindle of the vice; and
rotating the drive spindle with the socket wrench.

14. The method according to claim 13, wherein drive device is fastened on the vice in order to couple the drive device with the vice.

15. The method according to claim 13, wherein socket wrench is moved via the drive spindle of the vice by turning a rotary handle.
